(19) United States
(12) Patent Application Publication
(10) Pub. No.: US 2015/0355801 A1
(43) Pub. Date: Dec. 10, 2015

(54) RECORDED HISTORY FEATURE IN OPERATING SYSTEM WINDOWING SYSTEM

(71) Applicant: International Business Machines Corporation, Armonk, NY (US)

(72) Inventors: Kulvir S. Bhogal, Fort Worth, TX (US); Michael C. Hollinger, Austin, TX (US); Jennifer E. King, Austin, TX (US); Christina K. Lauridsen, Palo Alto, CA (US); Robert R. Peterson, Austin, TX (US)

(21) Appl. No.: 14/629,810

(22) Filed: Feb. 24, 2015

Related U.S. Application Data
(63) Continuation of application No. 14/296,489, filed on Jun. 5, 2014.

(51) Int. Cl. G06F 3/0484; G06F 9/54

(52) U.S. Cl. CPC G06F 3/0484; G06F 9/54

(57) ABSTRACT

Recording the video display of an application independently of the video displays of other applications and regardless of the characteristics of the video display—for example, regardless of whether the application is running in the foreground or the background or whether its display is fully visible, partially visible, or not visible at all on a monitor or other display device.

### BACKGROUND OF THE INVENTION

The present invention relates generally to the field of recording and playback, and more particularly to the recording and playback of computer activity.

As computers get faster and more powerful over time, the opportunities for computers to utilize more computationally intensive capabilities that run in the background also increase exponentially. In addition, driving new computation-, storage-, and network-intensive workloads for thin clients will increase customer demand for these hardware resources. There are many times where it might be useful to revisit in the present actions performed or events that occurred on a computer in the past. There exists known computer software for recording the visual display, or a portion thereof, of a computer as the computer runs. By using this existing software, the activities of all applications running visibly on the screen or screen portion will be effectively recorded, as a series of images, as part of the process of recording the computer's visual display.

### SUMMARY

According to three aspects of the present invention there is a method, computer program product and/or system which performs the following steps (not necessarily in the following order): (i) runs first application software programmed to generate a first video display that is: (a) displayed on a display device when the first application is running in the foreground, and/or (b) not displayed or only partially displayed on the display device when the first application is running in the background; (ii) saves a first video stream of at least a portion of the first video display; and (iii) creates a first video file corresponding to the saved first video stream. The saved first video stream does not include any video displays generated by any other application programs. The saved first video stream is saved regardless of whether the first application is: (i) running in the foreground; (ii) running in the background; (iii) completely visible; (iv) partially visible; and/or (v) not visible at all. A first machine logic module controls, at least, the saving of the first video stream.

### BRIEF DESCRIPTION OF THE DRAWINGS

FIG. 1 is a schematic view of a first embodiment of a system according to the present invention;

FIG. 2 is a flowchart showing a method performed, at least in part, by the first embodiment system;

FIG. 3 is a schematic view of a machine logic (for example, software) portion of the first embodiment system; and

FIG. 4 is a screenshot view generated by the present invention.

### DETAILED DESCRIPTION

Some embodiments of the present invention include a method for recording and playback of the visual display of an application window or set of windows on a computing device. In some embodiments, when multiple windows are recorded, each recorded window is recorded as a separate and independent video with respect to every other recorded window. In some embodiments, windows can be recorded automatically or on-demand and regardless of their on-screen characteristics, and multiple independent windows or window sets may be recorded simultaneously. In some embodiments, windows “running in the background” can be recorded, which means an application's activity will be recorded as if the application were controlling a visible window, even though the application is not controlling any visible window.

This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

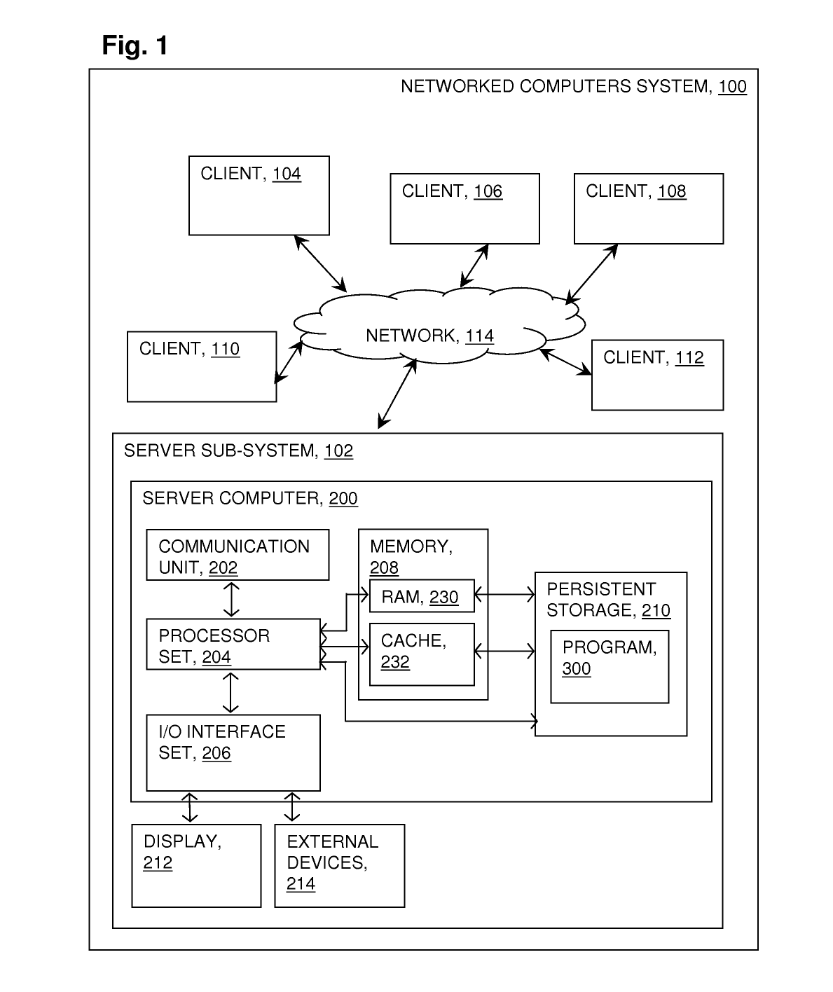

An embodiment of a possible hardware and software environment for software and/or methods according to the present invention will now be described in detail with reference to the Figures. FIG. 1 is a functional block diagram illustrating various portions of networked computers system 100, including: server sub-system 102; client sub-systems 104, 106, 108, 110, 112; communication network 114; server computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. EXAMPLE EMBODIMENT

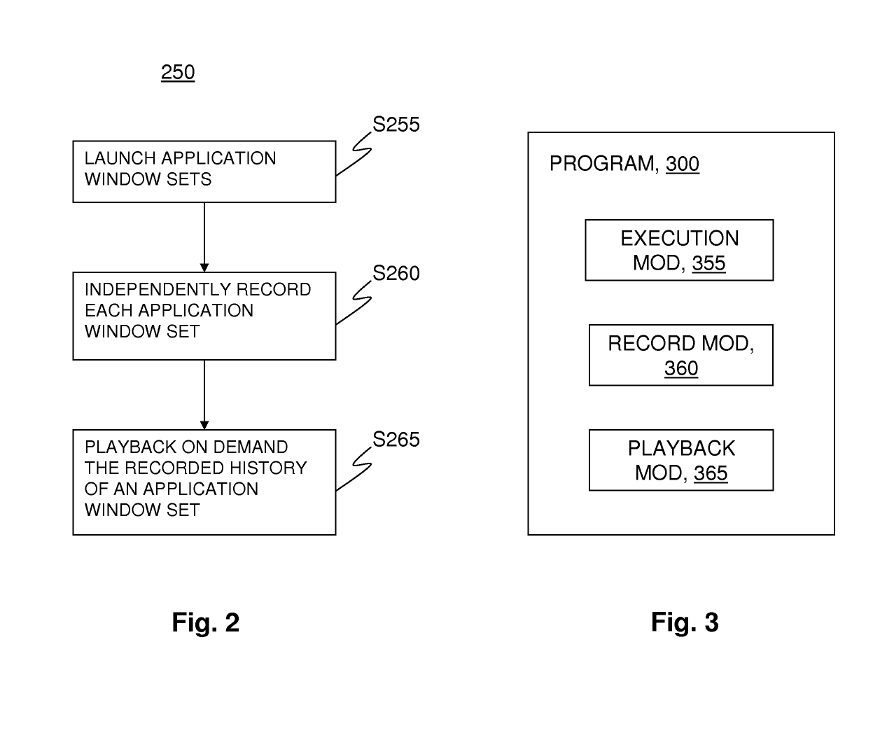

FIG. 2 shows flowchart 250 depicting a method according to the present invention. FIG. 3 shows program 300 for performing at least some of the method steps of flowchart 250. This method and associated software will now be discussed, over the course of the following paragraphs, with extensive reference to FIG. 2 (for the method step blocks) and FIG. 3 (for the software blocks).

Processing begins at step S255, where execution module (“mod”) 355 launches and runs applications. In this example, execution mod 355 has launched a word processing application in response to a user request to open a word processing file. Execution mod 355 has also launched a web browser, also in response to a user request. In general, the applications launched may be of any type and/or number. Furthermore, each may use one or more windows over the course of its execution. Each window may, at any given time, cover part or all of one or more screens, or not be visible on a screen at all. Each may also be “active” in the sense of having the focus for user input, or “inactive” in not having such focus. If tentatively visible, a window may be in the foreground (not covered at all by other windows) or in the background (partially or completely covered by at least one other window).

A window may be independent or it may be part of a set of windows that, for the purposes of the present disclosure, are treated as a single unit. For example, there may be one independent window for each of two documents currently opened in a word processing application. Alternatively, the two documents may share the same window, or there may be multiple temporary or persistent windows associated with a single document in a word processing application, such as an editing window, a search window, and a dialog box. Whether a window is independent or part of a multi-window set may be determined in any number of ways, including but not necessarily limited to: (i) by design and/or by reference to object parameters, such as whether or not a window has the run-time property of being a dependent child of another window; (ii) by explicit user selection, such as by a user explicitly indicating that two or more windows or window classes should be treated as a set; and/or (iii) functionally or by implicit user selection, such as by whether two windows pertain to the same application or file, or whether a user's past actions suggest an interest by that user in correlating the activities of a particular set of windows or window classes. In each case, each single independent window or multi-window set is hereinafter interchangeably referred to as either a window or a window set.

Processing proceeds to step S260, where record mod 360 records each open window set. In this example, record mod 360 begins recording the word processing window set when the word processing document is opened from the file system. It also begins recording the web browser window set when that application is launched. Each of these window sets is recorded automatically, simultaneously, and without disruption to the user's experience. Recording occurs regardless of window size, position, state (for example, maximized or minimized), foreground/background location relative to other windows (such as completely visible or partially or completely obscured by other windows), and focus (active/inactive). Each window set is recorded independently, so that a separate, independent recorded history is produced for each of the two open window sets that can later be accessed for playback. Each recording includes video, audio, and associated metadata (for example, each point in the web browser recording where a new website is visited is tagged accordingly with information about that website). Each recording is also compressed, resulting in considerable space savings given the relatively static nature of typical word processing and web browsing sessions. In this example, the user begins work on the opened word processing document after minimizing the browser window, which is pointed to a web page that refreshes every minute with new data.

Those of skill in the art will recognize that numerous alternatives are possible. For instance, the system may be pre-configured to only record certain classes of window sets, such as those associated with word processing documents, or recording may be triggered manually in all or in only select cases, such as via a title bar icon or menu item. The system may only record certain modalities, such as video, or only at certain times, such as when the window is not minimized. Compression may not be used, and a maximum duration or file size may be specified, after which previously recorded data may be overwritten. There may be a tool for a user to configure recording parameters for all recordings or by application or window type, which parameters may include items such as file size, recording time, recording quality, compression scheme, file retention time, types of activity to record (for example, keystrokes, mouse clicks, touches), recording modalities (for example, audio, video), and/or recording triggers (for example, only when in foreground, only when active). Alternatively or in addition, recording criteria may be adjusted automatically based on factors such as past user access to each application window set record.

Processing proceeds to step S265, where playback mod 365 plays back a previously recorded history stream at a user's request. Here, the user decides to take a break from word processing and check out the web page that has been refreshing every minute since being opened. The user maximizes the browser window and uses the playback controls in the title bar to quickly review all the updates that have occurred to the web page data since the user first launched the page. Alternatively, the user may select the playback file from a list of files, or by searching through a collection of recorded files using characteristics such as application, date, keyword, and so on. An administrative/management tool with a convenient user interface may be provided to allow the user to organize, summarize/annotate, select, retrieve, and/or view each recording.

### III. FURTHER COMMENTS AND/OR EMBODIMENTS

Some embodiments of the present invention recognize that there are many times when it may be desirable to revisit in the present actions performed or events that occurred on a computer in the past. For example, perhaps a user has filled out a form on a web page that is now submitted or has significantly modified a slide presentation and would like to go back and review all the changes that were made. Potential use cases may include: (i) an individual user who wants to review past actions (for example, the user has made several changes to a document and needs to recall what was done or, on starting the day, refresh on what was changed yesterday); (ii) revision visualization for collaborative document editing (for example, a user edits a presentation and uploads it, along with its associated video, to a document repository; other users may then view the abridged playback to get a summary of what changed); (iii) support services (for instance, videos sent from users to support service personnel, and vice versa, may provide greater ease of conveying information than sifting through logs or conveying steps in words); and/or (iv) system administrators, who, when changing shifts, for example, can view a summary of recent interaction with systems management software to get up to speed quickly before starting their work.

Accordingly, some embodiments of the present invention include an added feature implemented at the operating system level which, when enabled by the user, records activity for each application window individually. With this feature a user can play back any interaction they have had with their computer. Because video still utilizes significant storage today, a buffer for each application is employed in some embodiments to cap the size of the videos. For example, each window may have a buffer of 30 minutes of recorded history by default so that only the last 30 minutes of activity is stored. For important applications, users may set the buffer to much longer periods of time so that they may revisit interactions they have had with their system for, say, the past several days. In some embodiments, the video capability may also be an intelligent system, learning from user playback behavior to set appropriate recording times.

For greater efficiency, in some embodiments of the present invention the application video may automatically cut time when no interaction is taking place with the application. This may be done at record time or after the recording has ended (for example, upon closing the application or initiating playback). In some embodiments of the present invention, videos may be accessed by the user via a separate user interface, and/or associated with and accessed from an application or a specific document.

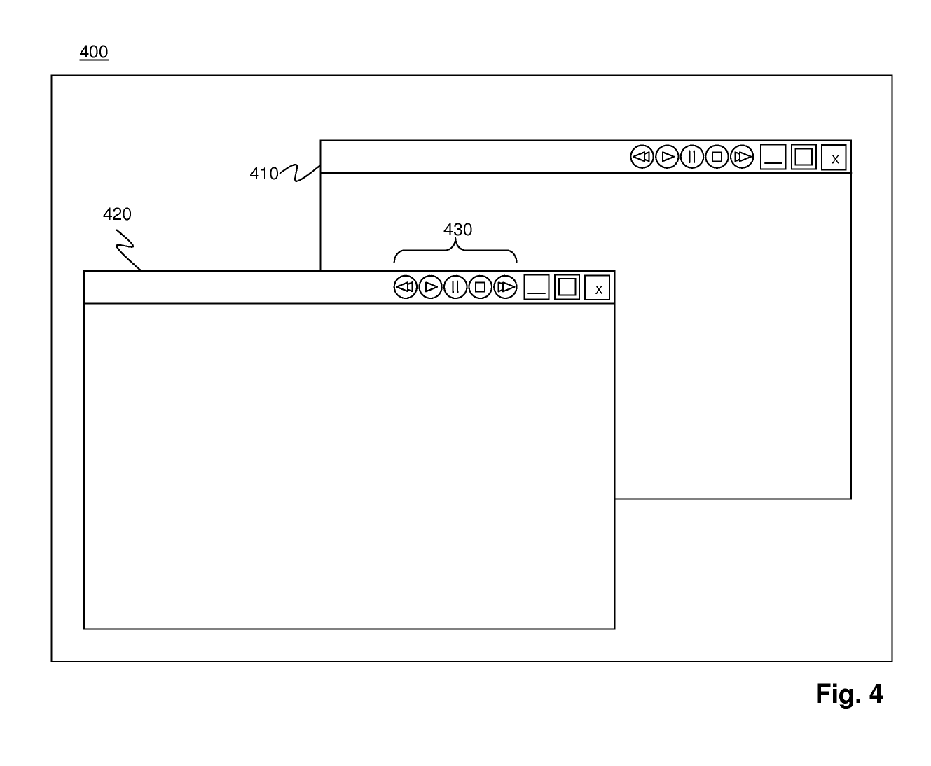

Shown in FIG. 4 is screenshot 400 of an embodiment of the present invention. Screenshot 400 includes windows 410 and 420, each with history playback feature control set 430. Screenshot 400 illustrates how this embodiment is implemented from a user interface perspective. Each window has some additional menu items for the history playback feature in addition to the standard “maximize”, “minimize”, and “close” options. These are embodied in screenshot 400 as playback feature control sets 430, each having a set of navigation tools for requesting and controlling playback of the recorded history of the window to which they are attached. In addition, this embodiment uses the best video capture and compression techniques known in the art to ensure the video capture is optimized for use of low computational and storage resources. Each window records independently whether it is in the foreground (currently, window 420) or background (currently, window 410), creating its own independent history playback file on the file system. The user may elect to set an expiration period for these recorded videos, so that if an application is not used for, say, X number of days, then the associated recording is deleted to save space. Other units of time may also be used.

Another way to administer recordings in this embodiment is through an administration tool (not shown) that lists all currently open and recording applications, as well as the contents of a repository for recordings from closed applications. A user who wants to access a recording from an application that was terminated, say, 10 minutes ago, could do so with this tool. All recordings are saved unless replaced by more recent video footage. The user can also use the tool to quickly view all applications that are open and being recorded.

In some embodiments of the present invention, the repository may further index and save recordings based on related events that occur within the operating system, such as file open/close/save operations, dialog box creation, notifications, or even interaction/mouse clicks from the user. These events may then be combined with the recordings. The contents of these recordings and events may then be searched as well, to provide a further index and context to the user's actions related to a particular application.

Some embodiments of the present invention may include one, or more, of the following features, characteristics and/or advantages: (i) make it possible to revisit what has been done in the past on a computer regardless of the application; (ii) include a system that is part of the operating system and that passively records all windows; (iii) record continuously over time within a buffer for each window; (iv) record all operating system windows individually; (v) record a window even when it is inactive; (vi) record window/user interface elements; (vii) are designed for individual application windows; (viii) associate metadata about use activity with each recording or section thereof; (ix) use video; (x) use compression techniques to delete unchanging video frames; (xi) treat each application individually; (xii) allow for the recording and saving of content at a fine level of granularity; (xiii) provide a buffering, continuous recording system that is “always on,” allowing users to instantly save a “flight recorder” of their application interactions over some configurable period of time; (xiv) always record data, whether the app is in the foreground or background (that is, when it is not active or even visible to the user); (xv) buffer, save, and/or delete data automatically based on rules set by the user or administrator; (xvi) allow playback and saving of closed applications; and/or (xvii) include policies such as an expiration period that allow for a recorded session to be saved until some future date for permanent archival.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Data communication: any sort of data communication scheme now known or to be developed in the future, including wireless communication, wired communication and communication routes that have wireless and wired portions; data communication is not necessarily limited to: (i) direct data communication; (ii) indirect data communication; and/or (iii) data communication where the format, packetization status, medium, encryption status and/or protocol remains constant over the entire course of the data communication.

Receive/provide/send/input/output: unless otherwise explicitly specified, these words should not be taken to imply: (i) any particular degree of directness with respect to the relationship between their objects and subjects; and/or (ii) absence of intermediate components, actions and/or things interposed between their objects and subjects.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

What is claimed is:

1. A method comprising:
running first application software programmed to generate a first video display that is: (i) displayed on a display device when the first application is running in the foreground, and/or (ii) not displayed or only partially displayed on the display device when the first application is running in the background;
saving a first video stream of at least a portion of the first video display; and
creating a first video file corresponding to the saved first video stream;
wherein:
the saved first video stream does not include any video displays generated by any other application programs;
the saved first video stream is saved regardless of whether the first application is: (i) running in the foreground, (ii) running in the background, (iii) completely visible, (iv) partially visible, and/or (v) not visible at all; and
a first machine logic module controls, at least, the saving of the first video stream.

2. The method of claim 1 wherein the first machine logic module is:
at least substantially in the form of software; and
part of an operating system, where the operating system also determines whether the first application runs in the background or runs in the foreground.

3. The method of claim 1 wherein:
during at least a substantial portion of the saving of the first video stream, the first application program is running in the background.

4. The method of claim 1 further comprising:
running second application software programmed to generate a second video display that is displayed on the display device;
wherein:
the second application software is run during at least a portion of the saving of the first video stream; and
the saved first video stream does not include the second video display.

5. The method of claim 4 further comprising:
saving a second video stream of at least a portion of the second video display; and
creating a second video file corresponding to the saved second video stream;
wherein:
the saved second video stream does not include any video displays generated by any other application programs;
the saved second video stream is saved regardless of whether the second application is: (i) running in the foreground, (ii) running in the background, (iii) completely visible, (iv) partially visible, and/or (v) not visible at all; and
the first machine logic module further controls the saving of the second video stream.

6. The method of claim 1 wherein the first video display includes a user interface portion that receives user input to determine when to start and stop saving the first video stream.

7. The method of claim 2 further comprising:
receiving input from a user to play back at least a portion of the first video file; and
responsive to the user input, playing back the at least a portion of the first video file;
wherein:
the user input is received through a set of playback controls attached to a frame of a window containing the first video display.
